(19) United States
(12) Patent Application Publication
(10) Pub. No.: US 2017/0238517 A1
(43) Pub. Date: Aug. 24, 2017

(54) FISH HOOK STOPPER

(71) Applicant: DONALD S. NADLER, INDEPENDENCE, MO (US)

(72) Inventor: DONALD S. NADLER, INDEPENDENCE, MO (US)

(21) Appl. No.: 15/589,630

(22) Filed: May 8, 2017

Related U.S. Application Data
(63) Continuation of application No. 29/534,720, filed on Jul. 30, 2015, now Pat. No. D786392.

(51) Int. Cl. A01K 91/06; A01K 99/00; A01K 83/00

(52) U.S. Cl. CPC A01K 91/06; A01K 83/00; A01K 99/00

(57) ABSTRACT

A method and apparatus for preventing a fish hook from being swallowed by a fish is provided. The apparatus includes a main body portion and a filament portion extending from the main body portion. The main body portion is positioned on a fishing line between a fishing rod and a hook. The filament portion extends generally orthogonally to the fishing line. The filament prevents the hook and line from being pulled beyond a predetermined amount into the fish's gut.

### CROSS-REFERENCE TO RELATED APPLICATIONS

This application claims priority pursuant to 35 U.S.C. 119(e) to co-pending U.S. Design patent application Ser. No. 29/534,720, filed Jul. 30, 2015, the entire disclosure of which is incorporated herein by reference.

### FIELD OF THE INVENTION

The present invention relates fishing equipment. More specifically, the present invention is concerned with a method and an apparatus to prevent a hook located at the end of a fishing line from being swallowed by a fish.

### BACKGROUND OF THE INVENTION

Fishing is a popular outdoor activity, in which a hook with bait or a lure attached is located at the end of a fishing line. It is common that the fish will swallow the hook along with the bait/lure, making it difficult to remove the hook without harming the fish.

Consequently, it would be beneficial to provide a system, method and/or apparatus for preventing a hook from being swallowed by a fish.

### SUMMARY OF THE INVENTION

The present invention comprises a fish hook stopper comprising a main body portion positioned on a fishing line between a fishing rod and a hook, and a filament portion extending from the main body portion in a direction generally orthogonal to the fishing line. A hole extends through the main body portion to allow the main body to be placed on the fishing line.

In some embodiments the main body portion is generally a rubber or other elastic material. In some such embodiments, the hole through the main body has a diameter smaller than the diameter of a fishing line on which the main body is designed to be applied. In such embodiments, when the main body is positioned on the fishing line, the elastic material will clamp around the line to prevent the main body from easily sliding up and down the line when such movement is not intended or desired by the user.

In some embodiments, the filament is a fluorocarbon material, which generally does not stretch, is generally clear and virtually invisible in water, and is capable of bending when appropriate force is applied. In some embodiments, the filament is inserted through the main body utilizing a fid, needle, marlinespike or other similar tool to pierce the main body and slide the filament there-through.

In use the main body is positioned on the fishing line and adjusted to an appropriate spacing away from the hook at the end of the line such that the hook can enter a fish's mouth but cannot be swallowed due to the filament preventing the hook and line from being pulled into the fish's gut.

In some embodiments, a single filament is utilized. In other embodiments, two or more filaments are utilized.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims.

FIG. 1 is perspective view of a fish hook stopper of an embodiment of the instant invention positioned on a fishing line between a fishing rod and a hook.

FIG. 2 is a perspective view of the fish hook stopper of FIG. 1, showing the hook within the mouth of the fish and the filament extending across the outer surface of the fish's mouth so as to prevent the hook from being swallowed by the fish.

FIG. 3 is a perspective view of a fish hook stopper of another embodiment, showing a hook within the mouth of a fish.

FIG. 4 is a front elevation view of the fish hook stopper of FIG. 1, with the rear view being a mirror image thereof.

FIG. 5 is a side elevation view of the fish hook stopper of FIG. 1, with the opposing side view being a mirror image there.

FIG. 6 is a top plan view of the fish hook stopper of FIG. 1, with the bottom view being a mirror image thereof.

FIG. 7 is a front elevation view of another embodiment of the fish hook stopper of the instant invention, with the rear elevation view being a mirror image thereof.

FIG. 8 is a side elevation view of the fish hook stopper of FIG. 7, with the opposing side view being a mirror image thereof.

FIG. 9 is a top plan view of the fish hook stopper of FIG. 7, with the bottom view being a mirror image thereof.

FIG. 10 is a front elevation view of the fish hook stopper of FIG. 3, with the rear elevation view being a mirror image thereof.

FIG. 11 is a side elevation view of the fish hook stopper of FIG. 3, with the opposing side view being a mirror image thereof.

FIG. 12 is a top plan view of the fish hook stopper of FIG. 3, with the bottom view being a mirror image thereof.

### DETAILED DESCRIPTION OF A PREFERRED EMBODIMENT

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

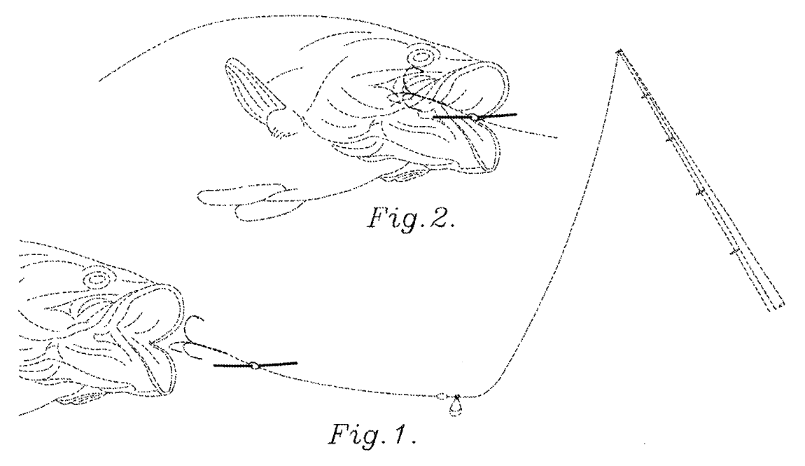

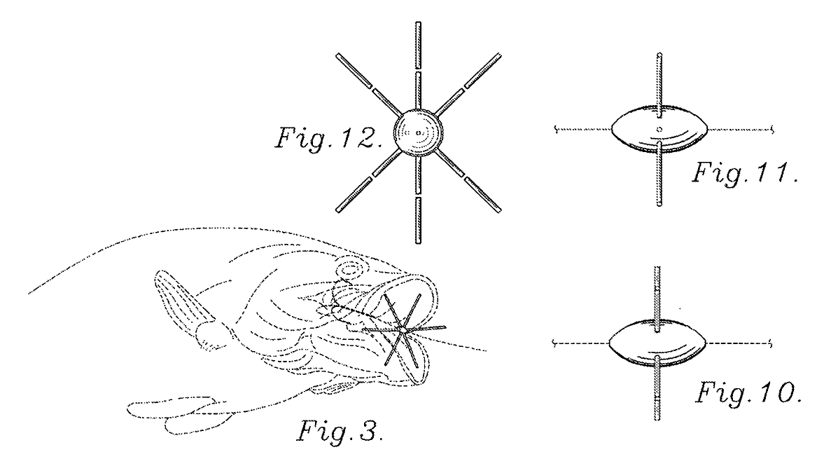

Referring to FIG. 1, a preferred embodiment of the apparatus includes a main body portion that is positionable on a fishing line between a fishing rod and a hook, and a filament portion extending from or through the main body portion in a direction generally orthogonal to the fishing line. In the embodiment shown in FIG. 1, a single filament is shown. A hole extends through the main body portion to allow the main body to be placed on the fishing line. In some embodiments the main body portion is generally a rubber or other elastic material. In some such embodiments, the hole through the main body has a diameter smaller than the diameter of a fishing line on which the main body is designed to be applied. In such embodiments, when the main body is positioned on the fishing line, the elastic material will clamp around the line to prevent the main body from easily sliding up and down the line when such movement is not intended or desired by the user. In some embodiments, the filament is a fluorocarbon material, which generally does not stretch, is generally clear and virtually invisible in water, and is capable of bending when appropriate force is applied. In some embodiments, the filament is inserted through the main body utilizing a fid, needle, marlinespike or other similar tool to pierce the main body and slide the filament there-through. In use the main body is positioned on the fishing line and adjusted to an appropriate spacing away from the hook at the end of the line such that the hook can enter a fish's mouth but cannot be swallowed due to the filament preventing the hook and line from being pulled into the fish's gut.

FIG. 2 is a perspective view of the fish hook stopper of FIG. 1, showing the hook within the mouth of the fish and the filament extending across the outer surface of the fish's mouth so as to prevent the hook from being swallowed by the fish.

FIG. 3 is a perspective view of a fish hook stopper of another embodiment, showing a hook within the mouth of a fish. In the embodiment shown in FIG. 3, three filaments are shown extending through the main body portion.

FIG. 4 is a front elevation view of the fish hook stopper of FIG. 1, with the rear view being a mirror image thereof.

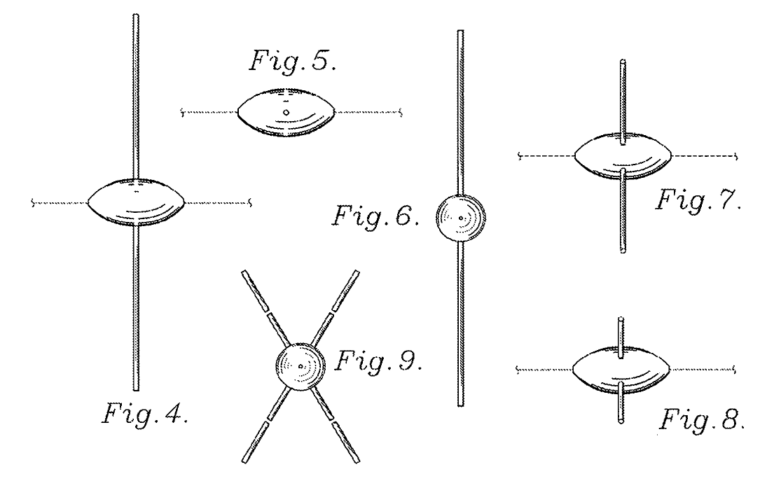

FIG. 5 is a side elevation view of the fish hook stopper of FIG. 1, with the opposing side view being a mirror image there.

FIG. 6 is a top plan view of the fish hook stopper of FIG. 1, with the bottom view being a mirror image thereof.

FIG. 7 is a front elevation view of another embodiment of the fish hook stopper of the instant invention, which embodiment includes two filaments extending through the main body portion. The rear elevation view is a mirror image of the front elevation view of FIG. 7.

FIG. 8 is a side elevation view of the fish hook stopper of FIG. 7, with the opposing side view being a mirror image thereof.

FIG. 9 is a top plan view of the fish hook stopper of FIG. 7, with the bottom view being a mirror image thereof.

FIG. 10 is a front elevation view of the fish hook stopper of FIG. 3, with the rear elevation view being a mirror image thereof.

FIG. 11 is a side elevation view of the fish hook stopper of FIG. 3, with the opposing side view being a mirror image thereof.

FIG. 12 is a top plan view of the fish hook stopper of FIG. 3, with the bottom view being a mirror image thereof.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A fish hook stopper comprising
a main body portion; and
a filament portion extending from said main body portion;
wherein said main body portion is positionable on a fishing line; and
wherein said filament portion extends generally orthogonally to the fishing line.

2. The fish hook stopper of claim 1 further comprising a hole extending through said main body portion for receiving the fishing line.

3. The fish hook stopper of claim 1 wherein said main body portion comprises an elastic material.

4. The fish hook stopper of claim 3 wherein said main body portion comprises a rubber material.

5. The fish hook stopper of claim 3 further comprising a hole extending through said main body portion for receiving the fishing line.

6. The fish hook stopper of claim 5 wherein said hold has a diameter that is smaller than a diameter of the fishing line.

7. The fish hook stopper of claim 1 wherein said filament portion comprises a fluorocarbon material.

8. The fish hook stopper of claim 1 wherein said filament portion is generally clear.

9. The fish hook stopper of claim 1 wherein said filament portion comprises a material that does not stretch.

10. The fish hook stopper of claim 9 wherein said filament portion comprises a material that is capable of bending when appropriate force is applied.

11. A method of preventing a fish hook from being pulled into a fish's gut, the method comprising:
positioning a stopper on a fishing line;
extending a filament portion from a main body portion of the stopper in a direction generally orthogonal to the fishing line;
adjusting a spacing of the stopper on the fishing line to an appropriate distance away from the hook such that the hook can enter a fish's mouth but cannot be swallowed.
